(19) United States
(12) Patent Application Publication
(10) Pub. No.: US 2010/0022151 A1
(43) Pub. Date: Jan. 28, 2010

(54) METHOD FOR MANUFACTURING AN ELASTIC NON-WOVEN COMPOSITE MATERIAL

(75) Inventor: Krzysztof D. Malowaniec, Heidenheim (DE)

Correspondence Address: Brinks Hofer Gilson & Lione/Ann Arbor, 524 South Main Street, Suite 200, Ann Arbor, MI, 48104, US

(73) Assignee: Paul Hartmann Aktiengesellschaft, Heidenheim (DE)

(21) Appl. No.: 12/573,972

(22) Filed: Oct. 6, 2009

Related U.S. Application Data
(63) Continuation of application No. PCT/EP2008/002092, filed on Mar. 15, 2008.

(30) Foreign Application Priority Data
Apr. 17, 2007 (DE) 10 2007 018 377.3

(51) Int. Cl. D04H 5/06; B32B 5/00; D04H 3/16

(52) U.S. Cl. 442/329; 156/178; 156/167; 156/179

(57) ABSTRACT

The disclosure relates to a method for producing a web of an elastic non-woven composite material including the following steps: Feeding and delivering a first non-woven layer in a longitudinal direction; feeding and delivering a plurality of elastic filaments; connecting the plurality of elastic filaments to a first side of the non-woven layer to form a composite material; at least in some regions overstretching of the first non-woven layer in the longitudinal direction by feeding the composite material through the gap of a pair of profiled, intermeshing stretching rollers, by which the composite material is stretched in the longitudinal direction, wherein the elastic filaments are arranged in the non-woven composite material such that they are substantially oriented in the longitudinal direction, so that they have at most about 10 intersecting points with each other per cm².

### CROSS-REFERENCE TO RELATED APPLICATIONS

This application is a continuation of International Application No. PCT/EP2008/002092 filed on Mar. 15, 2008, which claims the benefit of DE 10 2007 018 377.3, filed Apr. 17, 2007. The disclosures of the above applications are incorporated herein by reference.

### FIELD

The disclosure concerns a method for manufacturing an elastic non-woven composite material, an elastic non-woven composite material and a pant-shaped hygienic article with an elastic non-woven composite material.

### BACKGROUND

The statements in this section merely provide background information related to the present disclosure and may not constitute prior art.

Absorbent disposable articles such as pant-shaped hygienic articles often contain elastic components in order to improve the fit of the hygienic article, and thus wearing comfort

The elastic components often contain a plurality of elastifying agents, often in the form of elastic filaments that are connected, usually adhesively, in a prestressed state to essentially inelastic chassis material. In this way, a hip-edge area is preferably continuously elastified in the direction of its circumference. In known diapers, elastifying means are also provided in the front area and in the rear area. Likewise, the areas surrounding the leg openings, or as the case may be the circumferential areas forming the leg opening are formed in an elastic manner, in order to provide a close fit, over large areas, with the skin surface of the user, in order to prevent lateral leakage of bodily excretions. Raised cuff elements, which in addition to the elastic leg opening provide additional protection against lateral leakage, are already used in known diapers and are known (for example from EP-1184017-A1, EP-1199058-A1, EP-1308148-A2).

The use, between the hip edge and the crotch region, of non-woven composite materials with elastifying means is also known, which extend essentially in a transverse direction, in the form of elastic filaments, which in a prestressed state are connected, usually adhesively, to essentially inelastic chassis materials (stretch-bonding).

A method of manufacturing this kind of composite material has already been disclosed in WO01/88245. The method includes the extrusion of the elastic filaments and the connecting of the filaments to a non-woven material web by means of an adhesive, whereby the elastic filaments are connected in a prestressed state to the non-woven material web (stretch-bonding).

The disadvantage of this method is the necessity of using large amounts of adhesive in order to connect the elastic filaments to the non-woven web.

### SUMMARY

The present disclosure includes a method of producing an elastic non-woven material with elastic filaments that avoids this disadvantage.

This is accomplished with one method of the disclosure through feeding and delivering a first non-woven layer in a longitudinal direction; feeding a plurality of elastic filaments; connecting the plurality of elastic filaments to a first side of the non-woven layer to form a composite material; overstretching of the first non-woven layer, at least in some regions, in the longitudinal direction by feeding the composite material through the gap of a first pair of profiled, intermeshing rollers, by which the composite material is stretched in the longitudinal direction, wherein the elastic filaments are arranged in such a way that they are essentially oriented in the longitudinal direction, so that they have at most 10 intersecting points with each other per cm². The elastic filaments are preferably arranged in such a way that they run parallel to each other in the longitudinal direction.

Whereas in the state of the art documented in WO01/88245, the available extension of the laminate is achieved through stretch-bonding, that is, through the connecting of the prestressed elastic filaments to the non-woven material layer, with the method of the disclosure, at least one substantial part of the available stretching is achieved by subjecting the non-woven material layer to additional overstretching, i.e. a permanent deformation, in already bonded composite material, when the elastic filaments are essentially elastically warped during the stretching procedure. In accordance with the disclosure, this overstretching occurs by feeding the composite material through the gap of a first pair of profiled, intermeshing rollers. Consequently, the bonding of the elastic filaments and the non-woven material layer can take place at a point in time at which the elastic filaments have not been subjected to any significant prestressing. This has the advantage that the holding forces between the non-woven material layer and the elastic filaments are opposed by much fewer forces during the production of the non-woven composite material, and that consequently, less adhesive must be used, or that the use of an additional adhesion-promoting agent can even be dispensed with completely. In a preferred further development of the disclosure, the prestressing even amounts to less than about 1.5, in particular less than about 1.3, and additionally, in particular, less than about 1.2, additionally, in particular less than about 1.1, and preferably less than about 1.05. Here, a prestressing of about 1.5 means the stretching of the elastic filament by about 50%, i.e. for example, the stretching of a 10 cm long filament section to 15 cm.

Another advantage compared to stretch-bonding is the use of less material, because due to the overstretching of the non-woven material layer in accordance with the disclosure, the yield in running meters of elastic non-woven composite material web is higher, with the same use of material.

In one form of the method, the material web is stretched, during passing the composite material in a longitudinal direction through the gap of a first pair of profiled intermeshing rollers, by about 35-300%, in particular by about 50-200%. Here the extension or stretching is understood as the ratio of the change in length to the original length. A section with an original length of about 100 cm, for example, which is stretched to a length of about 150 cm, would thus be stretched by about 50%.

Depending on the extent of the permanent extension of the non-woven material layer associated with the stretching of the non-woven material, the result is a non-woven composite material with available extension (stretching capacity) in a longitudinal direction of about 35-300%, in particular about 50-200%.

Available extension or stretching capacity is understood as the ratio of the potential change in length to the original length of a section of the non-woven composite material. Here, the potential change in length is determined according to the following standardized method:

A 50 mm wide (dimension in the transverse direction of the non-woven composite material) and approx. 150 mm long (dimension in the longitudinal direction of the non-woven composite material) section of the non-woven composite material is acclimatized, without being under tension, for 24 hours at 23° C. and 50% relative air humidity. Then the section of non-woven composite material is stretched in a horizontal tension-testing device according to EN ISO 527-1 (1966), wherein the distance for the tension-testing device, i.e. the original length, is L0 100 mm. The section is firmly clamped at one end along its entire length of 50 mm into the stationary clamp jaw. At the other end, the section is firmly clamped along its entire length of 50 mm into the movable clamp jaw and put under pressure until a force of 10N is reached, the speed of the movable clamp jaw being 500 mm/min. Then the stretched length L1 of the section is measured in mm.

The available extension in % is then calculated according to the following formula:

$$Available extension [ \% ] = \frac{L 1 [ mm ] - L 0 [ mm ]}{L 0 [ mm ]} \times 100 \%$$

If no sufficiently large section of the non-woven composite material is available, the available extension will be determined on the basis of correspondingly smaller sections. In doing so, the load is set respectively at a value of 2 N/10 mm section width.

According to another inventive concept, the composite material, after the composite material has been fed through the gap of a first pair of profiled, intermeshing rollers, can be fed through the respective gap of additional pairs, in particular two additional pairs, preferably one additional pair of profiled, intermeshing rollers. In that way, the overstretching can take place in stages. In a further development of this inventive concept, the composite material is preferably more strongly stretched by the composite material being fed through the gap of the first pair of profiled, intermeshing rollers than by the composite material being fed through the respective gap of the additional pair of profiled, intermeshing rollers.

For financial reasons, it is advantageous for the non-woven material layer or the non-woven material layers to be made of inelastic material.

In a first alternative of the method of the present disclosure, it is provided that the elastic filaments are produced in the known manner in a separate manufacturing process, i.e. offline, and then wound continuously on rollers, and the elastic filaments are unwound from the roller during the manufacture of the non-woven composite material. However, it is conceivable and particularly advantageous if the procedure for producing the non-woven composite material incorporates the extrusion of the elastic filaments. Then it would be possible to speak of an inline production of the filaments.

As indicated above, it is particularly advantageous in terms of cost if the elastic filaments are bonded directly, i.e. in particular without additional adhesion-promoting agent, to the non-woven material layer. For this purpose, the elastic filaments can contain a polymer with permanent adhesive force. In the case of inline production of the elastic filaments, the permanent bond between the elastic filaments and the non-woven material layer can also be achieved by bringing the elastic filaments, soon after extrusion when they are not yet in a completely solidified state, into contact with the non-woven material layer. It is also conceivable and advantageous to feed the elastic filaments, together with the non-woven material layer, through a pressing gap, particularly a heatable pressing gap of a pair of rollers, particularly a pair of calendar rollers. In this way, the non-woven material layers and the elastic filaments can be fused together by means of thermally produced welding bonds over their entire surface, preferably however discontinuously by means of a bonding pattern, i.e. a pattern of bonded and non-bonded regions, in particular a dotted bonding pattern. Advantageously, the bonding pattern is applied in such a way that each of the elastic filaments runs through at least one bonding region, in particular at least two, and additionally, in particular, at least three bonding regions.

In the context of the step of stretching the non-woven composite material in its longitudinal direction, it can prove advantageous to fix the web of the non-woven composite material in a transverse direction, in order to counteract contraction of the web in a transverse direction, i.e. a reduction in the extension in the transverse direction. Nevertheless, it can also be advantageous to deliberately allow a small degree of contraction, in particular less than about 50%, additionally in particular less than about 30%, additionally in particular less than about 20%, and very particularly less than about 10 percent. Here, the contraction as a percentage is calculated according to the following formula:

$$Contraction [ \% ] = \frac{L Q 0 - L Q 1}{L Q 0} \times 100 \% ,$$

where LQ0 is the length of the web in a transverse direction before the process step of overstretching, and LQ1 is the length of the web in a transverse direction after the process step of overstretching.

In this manner, it is possible to provide the non-woven composite material with an at least minor degree of stretching capacity in a transverse direction.

In an additional form, the method of the present disclosure includes the feeding of a second non-woven material layer. Advantageously, it is fed and arranged in such a way that the first and the second non-woven material layer embed the elastic filaments in a sandwich-like manner. It has proved advantageous if the elastic filaments, together with the first and the second non-woven material layer, are fed through a pressing gap, in particular a heatable pressing gap of a pair of rollers. In this way, the non-woven material layers can be thermally bonded over their entire surface, however in this form discontinuously, by means of a bonding pattern, that is, a pattern of bonded and non-bonded areas, in particular a dotted binding pattern. Advantageously, the bonding pattern is applied in such a way that each of the elastic filaments runs through at least one bonding region, in particular at least two, and additionally in particular, at least three bonding regions.

The first and/or the second non-woven material layer can be produced in a known manner in a separate manufacturing process, i.e. offline, according to a process, such as for example, a spunbonded, card web, spun lace, or melt blown non-woven manufacturing process, and then wound continuously onto reels, the ready-made non-woven material layers then being wound off the reel during production of the elastic non-woven composite material. Alternatively, it is conceivable and advantageous if the process of producing the elastic non-woven composite material involves the inline manufacturing of at least one, and preferably both non-woven material layers, particularly according to the spunbonded production process.

The first non-woven material layer and preferably also the second non-woven material layer—if a second non-woven material layer is provided for—in one form has a weight per unit area of about 5-30 g/m², in particular of about 8-25 g/m², and additionally in particular of about 10-22 g/m², and very particularly of about 12-18 g/m².

The first and/or second non-woven material layer is essentially inelastic, particularly in the longitudinal direction and preferably also in the transverse direction. This helps reduce cost and enables the two-phase stretching characteristics described below. Inventively, an inelastic non-woven material layer is understood as a non-woven material which, after one-off stretching of a 25 mm wide strip of material by 30% of its original length at a rate of extension of 500 mm/min., either tears, or, after subsequent immediate release, displays permanent stretching of at least 7.5%. This means, for example, that a 100 mm long strip of material that is stretched to a length of 130 mm shows a length of at least 107.5 cm after release.

It is also proposed, as a further development of the present disclosure, that the stretching of the non-woven material be done in such a way that the first regions of the non-woven layer are stretched more strongly than the second regions of the non-woven layer. It is particularly advantageous not to overstretch the second regions at all in any substantial way. In one form, the first and second regions are then arranged in an alternating fashion, diagonally to the longitudinal direction of the web of the non-woven composite material. This results in the elastic characteristics of the non-woven composite material being characterized by two phases during use. Initially, the first, more strongly overstretched regions offer an initial, slight resistance to stretching in a longitudinal direction. After maximum extension of the strongly overstretched regions, additional extension of less strongly or not at all overstretched regions then requires a greater force that is obviously greater than the forces that can be expected during normal use. This two-phase quality gives the user an indication of the maximum stretching capacity of the material long before the material is at risk of tearing.

In an additional advantageous embodiment of the disclosure, the strength of the elastic filaments is about 4-700 dtex, in particular about 50-300 dtex, and also in particular about 100-200 dtex. In a further development of this inventive concept, the first and also the second non-woven material layer contain fibers with a first titer, measured in dtex, while the elastic filaments display a second titer, wherein the second titer is larger, preferably being up to about 100% or greater, particularly preferably up to about 200% or greater, particularly up to about 500% or greater, preferably however greater by at most about 5000%, particularly preferably by at most about 4000%, and very particularly preferably by at most about 3000% greater then the first titer. The percentage of the weight of the non-woven composite material accounted for by the elastic filaments preferably comes to less than about 40%, in particular less than about 30%, additionally in particular less than about 20%, additionally in particular less than about 15%, however preferably more than about 5%.

The elastic filaments contain or are comprised preferably of a thermoplastic polymer, in particular an extrudable polymer selected from the polyurethane group, elastic polyesters, elastic polyamides, elastic polyolefins, or elastic block copolymers. Extrudable elastic polymers that may be used in accordance with the present disclosure are disclosed in WO01/88245 and WO06/124092, which in this respect are included in their entirety in the disclosure.

The distance between the elastic filaments in a transverse direction preferably amounts to about 0.5-10 mm, particularly preferably about 1-5 mm, and particularly preferably about 1.2-3.5.

In addition, the disclosure also relates to a non-woven composite material that can be produced or is produced according to the method characterized above. The non-woven composite material, with a longitudinal direction and a transverse direction running vertically to it, preferably comprises a first non-woven material layer that is overstretched, at least in regions, which has a first side and a second side, as well as a plurality of elastic filaments oriented essentially in the longitudinal direction, said filaments being bonded to the first side of the non-woven material layer, whereby the elastic filaments are arranged in such a way that they have at most 10 intersection points with each other per cm², wherein the non-woven composite material displays a stretching capacity of about 35-300% in the longitudinal direction. In particular, the elastic filaments are oriented consistently in the longitudinal direction in such a way that they have at most about 8, in particular at most about 5, in particular at most about 3, additionally in particular at most about 1, and very particularly none at all, that is, 0, intersection points with each other per cm² of non-woven composite material. The elastic filaments preferably run parallel to each other in the longitudinal direction.

In addition, a disposable absorbent pant-shaped hygienic article is the subject of the present disclosure. The hygienic article is continuously closed in the direction of circumference, with a hip edge that forms a hip opening, and which has leg openings and a front and rear part with longitudinal-side edge sections, whereby there is a gap between the front part and the rear part in the longitudinal direction of the hygienic article, and which has an absorbent part that connects the front and rear parts in the longitudinal direction of the hygienic article, whereby the hip edge that is continuously closed in the direction of circumference and the leg opening is formed, wherein the longitudinal-side edge sections of a front part and a rear part are connected by the manufacturer, and whereby the front part and/or the rear part contain an inventive non-woven composite material or are comprised of the same, and whereby the longitudinal direction of the non-woven composite material runs essentially vertically to a longitudinal direction of the hygienic article. In particular, the extent of the non-woven composite material of the front part and/or the rear part in the longitudinal direction of the hygienic article amounts to about 8-50 cm, in particular about 10-40 cm, and also in particular about 12-30 cm.

The water-vapor permeability of the non-woven composite material amounts, in particular, to at least about 300 g/m²/24 hours, additionally in particular at least about 1000 g/m²/24 hours, additionally in particular at least about 2000 g/m²/24 hours, and additionally in particular at least about 3000 g/m²/24 hours, additionally in particular at least about 4000 g/m²/24 hours, additionally in particular at least about 6000 g/m²/24 hours measured according to DIN 53 122-1 (edition: 2001-08).

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

Further characteristics, details, and advantages of the disclosure are seen in the appended patent claims and in the various forms of the disclosure seen in the drawing and the subsequent description. The drawing shows:

FIG. 1 in schematic form, a sectional view of a device for implementing the method of the disclosure'

FIG. 2 a sectional view along a line A-A of the FIG. 1;

FIG. 3 a partial view of a sectional view of the FIG. 5 along the line B-B;

FIG. 4 an enlarged depiction of the engaging section of a pair of rollers;

FIG. 5 a section of composite material in a view from above;

FIG. 6 a sectional view of a section of a composite material along a line B-B;

FIG. 7 a section of an elastic non-woven composite material, seen from above, in a non-stretched state;

FIG. 8 a section of an elastic non-woven composite material in a stretched state;

FIG. 9 in schematic form, a lateral view of another device for implementing an additional inventive process;

FIG. 10 a view from above of a first embodiment of a pant-shaped hygienic article in a flattened state before being connected by the manufacturer to the longitudinal-side edge regions; and

FIG. 11 a perspective view of a pant-shaped hygienic article after connection by the manufacturer to the longitudinal-side regions.

The drawings described herein are for illustration purposes only and are not intended to limit the scope of the present disclosure in any way.

### DETAILED DESCRIPTION

The following description is merely exemplary in nature and is not intended to limit the present disclosure, application, or uses.

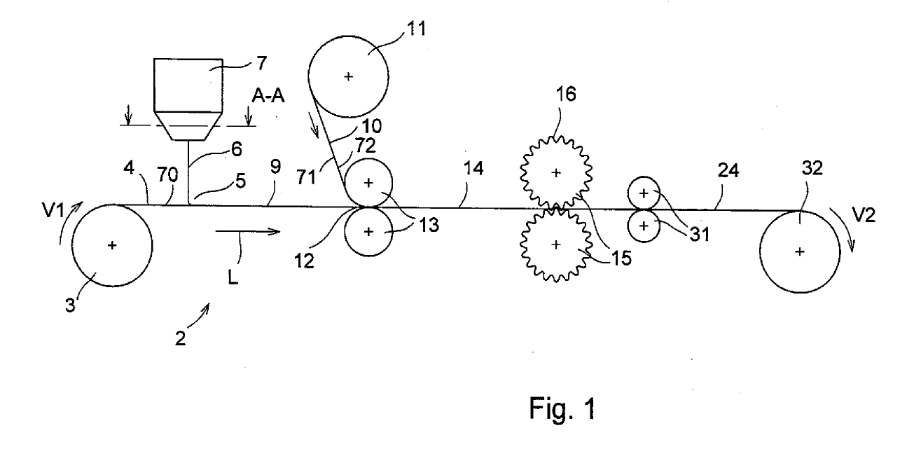

FIG. 1 presents a schematic view of a device, designated in its entirety with the reference sign 2, for implementing a method of the disclosure of producing an elastic non-woven composite material. From a reel 3, a first, already prefabricated inelastic non-woven layer 4, in particular a PP-spunbonded fabric layer with a weight per unit area of 18 g/m² is unreeled at a speed v1 and fed in a longitudinal direction L in the direction of a contact area 5, in which the elastic filaments 6 are deposited essentially without tension on a first side 70 of the first non-woven layer 4. In this instance, the elastic filaments 6 are produced inline by an extruder 7. It would also be conceivable to produce the elastic filaments 6 offline and to feed them continuously, as prefabricated material, for example off the reel, into the non-woven composite material production process.

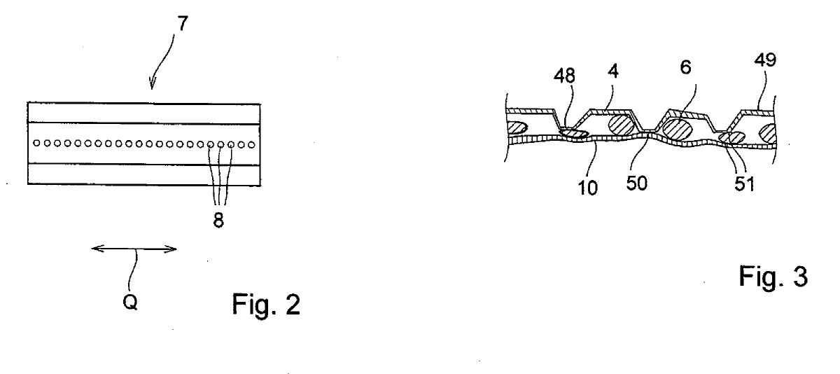

FIG. 2 presents a schematic view, which is not drawn to scale, of the head of the extruder 7 in cross section along a line A-A. Recognizable are the discharge nozzles 8 for the elastic filaments 6. The distance between the discharge nozzles amounts to approximately 3 mm.

Contact by the elastic filaments 6 with the non-woven material layer 4 in the contact area 5 in one form occurs at a point in time at which the extruded elastic filaments 6 are not fully solidified and are therefore still in a partially-melted and thus still adhesive state.

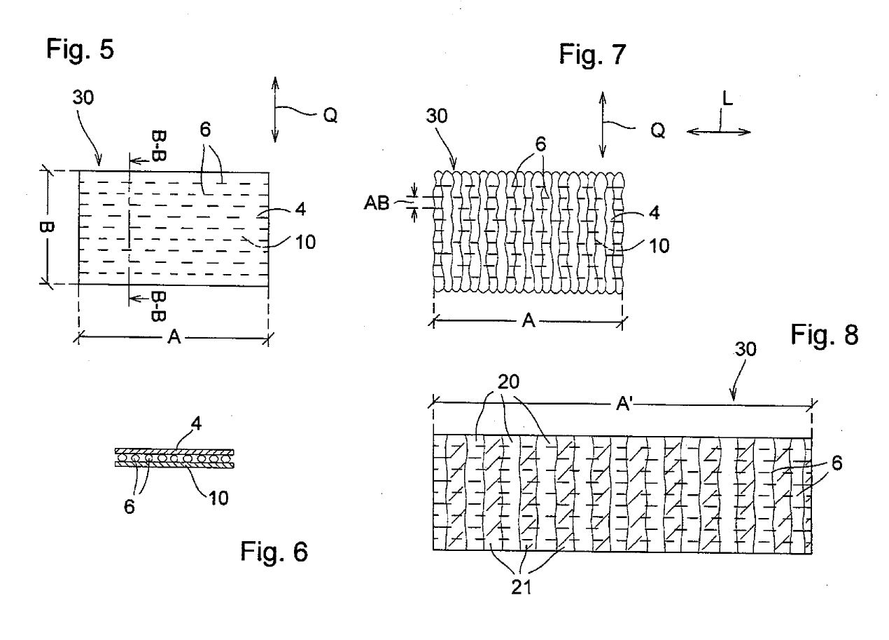

The prelaminate 9, consisting of the first non-woven material layer 4 and the elastic filaments 6, is coated in the instance shown with an additional, second, inelastic non-woven material layer 10, with a first side 72 and a second side 71, in particular a PP-spunbonded non-woven material layer with a weight per unit area of 18 g/m², which is reeled off a reel 11. The combining of prelaminate 9 and a second non-woven material layer 10 takes place immediately in front of a pressing gap 12 formed by a calendar roller pair 13 in such a way that the second side 71 of the second non-woven material layer 10 faces the first side 70 of the first non-woven material layer 4. The calendar roller pair 13 comprises a first, smooth roller and a second, in particular heated roller, designed with island-shaped elevations, so that with passage through the pressing gap, the prelaminate 9 and second non-woven material layer 10 can be permanently bonded by means of point-like bonding patterns, i.e. the formation of regions where there is bonding at various points 48 with non-bonded regions 49 surrounding them. During this process, both first melted bonds 50 are formed directly between first and second non-woven material later 4, 10 and subsequent melted bonds 51 between first and/or second non-woven material layers 4, 10 and the elastic filaments 6. Here, the non-woven material layers (4, 10) are arranged in such a way that the elastic filaments 6 are positioned between the first side 70 of the first non-woven material layer 4 and the second side 71 of the second non-woven material layer 10. FIG. 3 illustrates the described point-like bonding pattern in an enlarged partial view of a cross-sectional view along a line B-B in the FIG. 5.

Also, instead of thermal bonding using the described dot-bonding pattern, is bonding the non-woven material layers 4, 10 and the elastic filaments 6 by means of an adhesion promoting agent, in particular by using small amounts of a hot-melt adhesive. This would preferably be applied using known modules, such as hot-melt spray or slotted-head application devices, in particular to the first side 70 of the first non-woven material layer 4, in any case before the calendar roller pair 13. The calendar roller pair 13 could here be comprised of two smooth rollers, which compress the entire surface of the non-woven material 4, 10 and the elastic filaments 6, and in that way bring about the adhesion of the composite material.

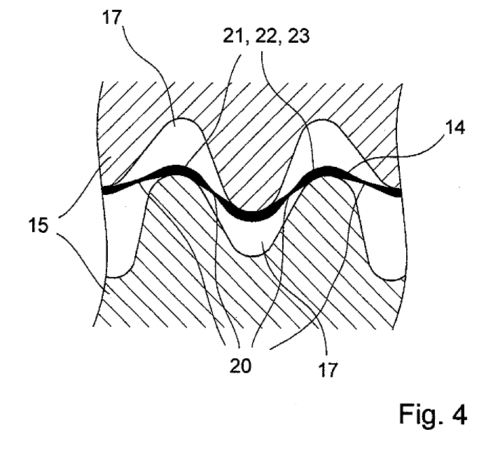

Subsequently, the composite material 14 formed in this way is fed into the gap of an extension roller pair 15. FIG. 4 shows, in an enlarged depiction, the engaging section of the extension roller pair 15. The rollers of this extension roller pair 15 feature a grooved surface 16, wherein the grooves 17 run transversely to the longitudinal direction L. The geometrical shapes of the grooves in the extension rollers are attuned in such a way that they can intermesh without touching, whereby the extent of the intermeshing and thus the extent of the stretching of the composite material 14 can be regulated. The geometrical shape of the grooves can be toothed in an undulated or angled manner, as shown in FIG. 4, or display other conceivable configurations. As FIG. 4 illustrates, the stretching of the composite material 14 takes place in such a way that the first regions 20 between the application segments 22 of the composite material 14, which are on the raised segments between the grooves 23, are stretched more strongly than the second regions 21, which correspond to the application segments 22. The stretching of the composite material 14 results in an overstretching of the non-woven material layers 4, 10, because the non-woven material layers 4, 10 are essentially inelastic in the longitudinal direction. This means that the non-woven material layers 4, 10 have experienced a permanent, inelastic deformation. The elastic filaments, on the other hand, are only elastically deformed by the stretching of the composite material 14. Consequently, the non-woven composite material 24 can be elastically deformed after the stretching process, wherein the extent of the available extension more or less corresponds to the prior stretching.

For the purpose of further illustration, FIG. 5 shows, in a view from above, a section 30 of the composite material 14 immediately before being fed through the gap of the extension roller pair 15, with the original length A=100 cm and the width B=60 cm. The elastic filaments have a fiber strength of 100 dtex. The fibers of both non-woven material layers have a fiber strength of 4 dtex. In a schematically illustrated cross section along B-B (FIG. 6), we can see the two non-woven material layers 4, 10 and the elastic filaments 6, which are arranged in an essentially tension-free, sandwich-like manner between them. An illustration of the dot-bonding pattern was dispensed with in FIG. 6. The dot-binding pattern is shown in detail in FIG. 3.

FIG. 7 shows this section 30 immediately after being fed through the gap of the extension roller pair 15, which initially results in stretching of the section by 100%, i.e. to a length of 200 cm. During this process, the first regions 20 of the non-woven layer 4, 10 are more strongly overstretched than the second region 21 of the non-woven layer 4, 10. First and second regions 20, 21 are arranged alternately in a strip-like manner transversely to the longitudinal direction L, as can be seen in the FIG. 8 described below. The restoring forces of the elastically deformed elastic filaments 6 that are bonded to the non-woven material layers 4, 10 result in the section 30 of the non-woven composite material 24 contracting to the original length A=100 cm. Because the stretching of the non-woven layers 4, 10 by 100% results in a permanent stretching (overstretching) of the non-woven layers, also by 100%, the quasi-surplus non-woven layer material, as can be seen in FIG. 7, leads to a crinkling/gathering of the non-woven material layers 4, 10. The distance AB between the elastic filaments, which are arranged essentially parallel to each other, amounts to 3 mm in a transverse direction Q. The elastic filaments 6 thus show 0 points of intersection with each other per cm². The weight per unit area of the non-woven material layers 4, 10 therefore amounts to 18 g/m² respectively. The weight of the elastic filaments 6 as a percentage of the total weight of the non-woven composite material 24 amounts to 8.5%.

The section 30 of the finished non-woven composite material 24 can now be elastically extended in longitudinal direction L to a length of 200 cm, that is, by 100% (FIG. 8). With this method therefore, compared to known “stretch-bonding,” significant savings on material, up to 100%, is possible, because with “stretch-bonding,” a section that could be extended to 200 cm would also require a 200 cm long non-woven material section, while the method described here requires the use of only 100 cm long non-woven material sections.

After feeding through the gap of the extension roller pair 15, it can be advantageous to counteract a constriction of the non-woven composite material web 14 in the transverse direction Q, which could result from shortening of the web in a longitudinal direction caused by the restoring forces of the elastic filaments 6. An additional roller pair 31 that fixes the web, at least at its two longitudinal ends, can serve this purpose. It is advantageous to counteract constriction, at least to the extent that the constriction, that is, the shortening of the web in the transverse direction Q, i.e. the width of the web relative to the original width, amounts to a maximum of 50%, in particular less than 30%, additionally in particular less than 20%, and very particularly less than 10%.

Ultimately, the non-woven composite material 24 in the case shown (FIG. 1) is continuously wound onto a reel 32 at the path speed v2. The speed v2 is here preferably selected as higher than the speed v1 in order to wind the web onto the reel with a certain prestress. It would also be conceivable and advantageous if the web of the non-woven composite material 24 were fed directly, i.e. without prior winding onto the reel 31, into the further processing intended for it, for example a rapid running machine for manufacturing pant-shaped hygienic articles. This would also be done with a path speed that is higher than the speed v1.

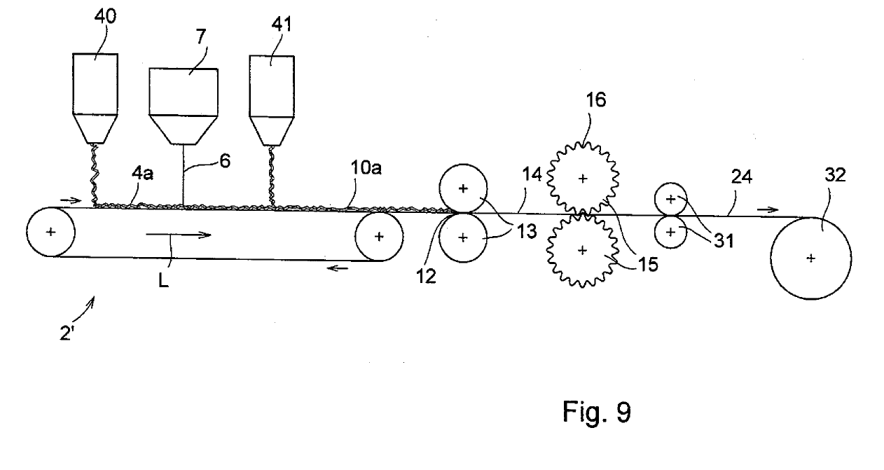

According to an additional form of a method of the present disclosure, it is advantageous if the method for manufacturing the non-woven composite material 24 includes the inline production of at least one, and preferably both non-woven material layers 4a, 10a, in particular according to the spunbonded fabric manufacturing process (spunbonding). The technology of spunbonding is familiar to the person skilled in the art. FIG. 9 is a schematic depiction of a preferred arrangement of the manufacturing device 2′. Instead of the reels 3, 11 shown in FIG. 1 for unreeling readymade non-woven material layers 4, 10, two spinning beams 40, 41 are shown schematically for the melt-spinning of spunbonded fabric layers 4a and 10a, which are still essentially non-bonded. The spunbonded fabric layers 4a and 10a are preferably (as it were in one process step) fully bonded by being fed through the calendar roller pair 13, and at the same time, bonded to each other and to the elastic filaments 6. Device modules and material components provided with the same reference signs correspond in other respects to the device modules and material components shown and described in more detail in FIG. 1.

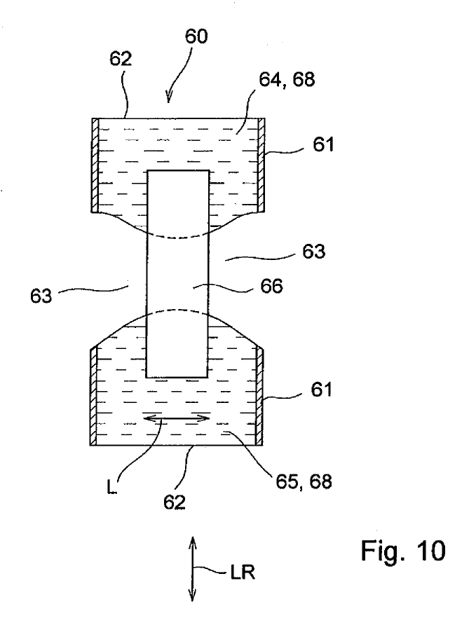

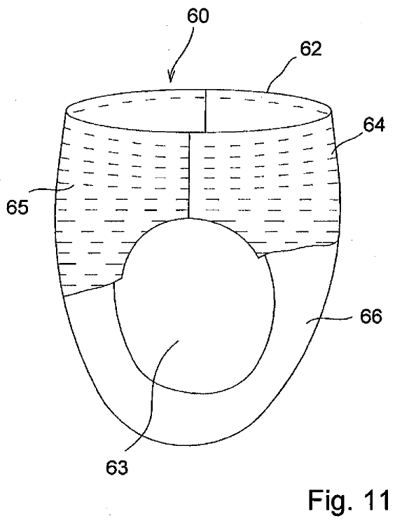

Finally, FIG. 10 shows a disposable pant-shaped absorbent hygienic article 60, however in a flattened, extended state before the manufacturer has connected the longitudinal-side edge sections 61 to a hip edge 62 that forms a continuously closed hip opening in the circumferential direction after the manufacturer has connected the longitudinal-side edge sections 61, and with leg openings 63 and with a front part 64 featuring longitudinal-side edge sections 61 and a rear part 65. The front part 64 and rear part 65 are at a distance from each other in a longitudinal direction LR of the hygienic article 60 and are connected in the longitudinal direction LR of the hygienic article by means of an absorbent part 66 which bridges the distance between the front part 64 and the rear part 65. FIG. 11 shows the disposable absorbent hygienic article 60 after the manufacturer has connected the longitudinal-side edge sections 61.

The absorbent part 66 is fixed to the side of the front and the rear part that faces the body. The absorbent part 66 features a backsheet that is impermeable to fluid, a topsheet that is permeable to fluids, and a fluid-absorbing and storing absorbent core that is arranged between them. The absorbent core in one form contains super-absorbent polymer particles and fibers, particularly natural fibers, particularly in the form of cellulose fluff.

The front part 64 and the rear part 65 are comprised of a non-woven composite material section 68, which in each case is detached, for example cut out or punched out of a non-woven composite material web 24 produced according to a method of the present disclosure, wherein the longitudinal direction L of the non-woven composite material web 24 runs essentially vertical to a longitudinal direction LR of the hygienic article 60. The length of the front part 64 amounts to 20 cm in the longitudinal direction LR, that of the rear part 65 amounts to 25 cm in the longitudinal direction LR. The extensibility of the front and rear part in the direction of the circumference of the hip opening, i.e. vertically to a longitudinal direction LR of the hygienic article 60, amounts to 100%, so that the size of the hip opening can be doubled, and thus adjusted to a plurality of clothing sizes.

It should be noted that the disclosure is not limited to the various forms described and illustrated as examples. A large variety of modifications have been described and more are within the scope of the present disclosure. These and further modifications as well as any replacement by technical equivalents may be added to the description and figures, without leaving the scope of the protection of the disclosure and of the present patent.

What is claimed is:

1. A method of manufacturing a web of an elastic non-woven composite material comprising the following steps:
feeding and delivering a first non-woven material layer in a longitudinal direction;
feeding a plurality of elastic filaments;
bonding the plurality of elastic filaments to a first side of the non-woven material layer in order to make a composite material; and
overstretching the first non-woven material layer at least in regions in the longitudinal direction by feeding the composite material through the gap of a pair of profiled, intermeshing rollers, by means of which the composite material is stretched in the longitudinal direction, whereby the elastic filaments in the non-woven material are arranged in such a way that they are essentially oriented in the longitudinal direction, so that they have no more than about 10 intersection points with each other per cm².

2. The method according to claim 1, characterized in that the non-woven composite material features a stretching capacity of about 35-300% in the longitudinal direction.

3. The method according to claim 2, characterized in that the non-woven composite material features a stretching capacity of about 50-200% in the longitudinal direction.

4. The method according to claim 1, characterized in that the method includes the extrusion of the elastic filaments.

5. The method according to claim 1, characterized in that the elastic filaments are directly connected to the first non-woven material later, wherein the elastic filaments, together with the non-woven material layer are fed through a pressing gap, in particular a heatable pressing gap of a second pair of rollers, in particular a calendar roller pair.

6. The method according to claim 1, characterized in that a web of the non-woven composite material is fixed along its transverse extent after overstretching the first non-woven material layer so that there is counteraction of constriction of the web in a transverse direction.

7. The method according to claim 6, characterized in that the constriction of the web of the non-woven composite material is less than about 50%.

8. The method according to claim 7, characterized in that the constriction of the web of the non-woven composite material is less than about 30%.

9. The method according to claim 8, characterized in that the constriction of the web of the non-woven composite material is less than about 20%.

10. The method according to claim 9, characterized in that the constriction of the web of the non-woven composite material is less than about 10%.

11. The method according to claim 1, characterized in that the method includes feeding a second non-woven material layer with a first side and a second side.

12. The method according to claim 11, characterized in that the second side of the second non-woven material layer is bonded to the first side of the first non-woven material layer, so that the elastic filaments are arranged in a sandwich-like manner between the first non-woven material layer and the second non-woven material layer and preferably also bonded to the second non-woven material layer.

13. The method according to claim 1, characterized in that at least one of the first regions of the first and second non-woven material layer are more strongly overstretched than the second regions of a respective non-woven material layer.

14. The method according to claim 1, characterized in that the second regions are essentially not overstretched.

15. The method according to claims 1, characterized in that the first regions and the second regions of at least one of the first and second non-woven material layer are arranged alternatingly in strip-like form transversely to the longitudinal direction.

16. The method according to claim 1, characterized in that the composite material, during feeding through the gap of a pair of profiled, intermeshing rollers is stretched by about 35-300%.

17. The method according to claim 16, wherein the composite material is stretched by about 50-200%.

18. The method according to claim 1, characterized in that the elastic filaments, essentially unstretched, particularly with a tension factor of less than about 1.5 are bonded to at least one of the first and the second non-woven material layer.

19. The method according to claim 1, characterized in that the strength of the elastic filaments amounts to about 4-700 dtex.

20. The method according to claim 19, wherein the strength of the elastic filaments amounts to about 50-300 dtex.

21. The method according to claim 20, wherein the strength of the elastic filaments amounts to about 100-200 dtex.

22. The method according to claim 1, characterized in that the elastic filaments are comprised of a thermoplastic, particularly an extrudable polymer selected from the group consisting of polyurethanes, elastic polyester, elastic polyamides, elastic polyolefins, and elastic block copolymers.

23. The method according to claim 1, characterized in that the elastic filaments are comprised of a polymer component with a permanent adhesive force.

24. The method according to claim 1, characterized in that at least one of the first and the second non-woven material layer is inelastic in at least one of the longitudinal direction and in the transverse direction.

25. An elastic non-woven composite material produced according to the method of claim 1.

26. The non-woven composite material according to claim 25, characterized in that the elastic filaments feature at most 8 points of intersection with each other per cm.

27. The non-woven composite material according to claim 25, characterized in that the strength of the elastic filaments amounts to about 4-700 dtex.

28. The non-woven composite material according to one of the previous claim 25, characterized in that at least one of the first non-woven material layer and the second non-woven material layer has a weight per unit area of about 5-30 g/m².

29. The non-woven composite material according to claim 25, characterized in that in a transverse direction, there is a distance between the elastic filaments of about 0.5-10 mm.

30. The non-woven composite material according to claim 25, characterized in that the percentage of the total weight of the non-woven composite material accounted for by the weight of the elastic filaments is less than about 40%.

31. The non-woven material according to claim 25, characterized in that at least one of the first non-woven material layer and the second non-woven material layer contain fibers with a first titer, measured in dtex, and that the elastic filaments have a second titer, wherein the second titer is greater, preferably up to 100% greater than the first titer.

32. A disposable absorbent pant-shaped hygienic article with a front part with a continuously closed hip edge that forms a hip opening and with leg openings and with longitudinal-side edge sections and a rear part wherein there is a space between the front part and rear part in the longitudinal direction of the hygienic article, and with an absorbent part that connects the front part and the rear part in the longitudinal direction of the hygienic article, wherein the hip edge, which is continuously closed in the direction of the circumference, and the leg openings are formed by the longitudinal-side sections of a front part and a rear part that are connected by the manufacturer, and whereby the front part and/or the rear part contain a non-woven composite material according to claim 25, and wherein the longitudinal direction of the non-woven composite material essentially runs vertically to a longitudinal direction of the hygienic article.

33. The disposable hygienic article according to claim 32, characterized in that the extent of the non-woven composite material of at least one of the front part and the rear part, in the longitudinal direction of the hygienic article amounts to about 8-50 cm.
